(19) United States
(12) Patent Application Publication
(10) Pub. No.: US 2025/0155604 A1
(43) Pub. Date: May 15, 2025

(54) METALENS STRUCTURES FOR THE MODULATION OF INCIDENT LIGHT

(71) Applicant: Board of Regents, The University of Texas System, Austin, TX (US)

(72) Inventor: Weidong ZHOU, Southlake, TX (US)

(21) Appl. No.: 18/946,385

(22) Filed: Nov. 13, 2024

Related U.S. Application Data
(60) Provisional application No. 63/598,310, filed on Nov. 13, 2023.

(51) Int. Cl. G02B 1/00; B82Y 20/00; G02F 1/01

(52) U.S. Cl. CPC G02B 1/005; B82Y 20/00; G02F 1/0113; G02F 2202/30; G02F 2202/32; G02F 2203/50

(57) ABSTRACT

A metalens and methods of manipulating light using a metalens are provided. In some aspects, a metalens comprises a slab or substrate and a plurality of regions or features distributed on the slab. In some instances, the slab can be formed from a material having a first refractive index, and the plurality of regions can be formed from a material having a second refractive index. In some instances, the first refractive index can be higher than the second refractive index, and in some aspects, the plurality of regions define an optical modulation or manipulation structure for light having a target wavelength λ or the target range of wavelengths Δλ.

### CROSS-REFERENCE TO RELATED APPLICATIONS

This application claims priority to U.S. Provisional Application No. 63/598,310 filed Nov. 13, 2023, which is incorporated herein by reference in its entirety.

### STATEMENT REGARDING FEDERALLY SPONSORED RESEARCH

This invention was made with government support under Grant No. W911NF1910108 awarded by the Army Research Office. The Government has certain rights in the invention.

### FIELD

The present application relates to flat optics or metalenses, methods of modulating light, and methods of making metalenses, more particularly to metalenses comprising photonic crystal slabs optical modulation structures for the modulation of incident light.

### BACKGROUND

Nanoscale materials, or metamaterials, have drawn increasing attention in recent years for their broadband, highly efficient capabilities of light modulation, such as phase modulation, by a flat medium. Metalenses are revolutionizing the photonics field by offering thin or flat optics which can have similar functions as traditional bulk optics. Such Metalens can be compact and can be easily integrated into optics and photonics systems, with a wide range of applications for example in imaging, AR/VR, consumer electronics, bio-optical sensing, and other commercial applications.

Current or conventional metalenses, however, are based on metamaterials that incorporate dielectric rods that have a very high aspects ratio are designed to achieve a desired function, which makes the structure hard to fabricate, easy to break, and cannot achieve a thin profile or dimension for certain applications. Further conventional metamaterials incorporate dielectric piller structures placed on a substrate, and accordingly the overall material thickness would be at least at micrometer scale to achieve the bending of light in the desired way.

In contrast to conventional optics, lenses, and/or metalenses, the technology described herein generally relates metalenses or flat optics that offers similar functions with a much thinner structure and in a connected dielectric slab, in some instances. Further, metalenses and/or flat optics described herein overcome the deficiencies in conventional optics or systems and offer high reliability and a simplified fabrication process.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the technology described herein are generally directed towards thin or flat optics, for instance a metalens which can be implemented for modulating, manipulating, controlling, and/or modifying light having a target wavelength λ or target range of wavelengths Δλ.

In some embodiments, a metalens is provided. A metalens can comprise a slab or substrate and a plurality of regions or features (e.g. optical features) distributed on the slab. In some instances, the slab can be formed from a material having a first refractive index, and the plurality of regions can be formed from a material having a second refractive index. In some instances, the first refractive index can be higher than the second refractive index, and in some aspects, the plurality of regions define an optical modulation or manipulation structure for light having a target wavelength λ or the target range of wavelengths Δλ.

In some embodiments a method of modulating light is provided. In some embodiments, a method comprises receiving, at a metalens, light from a light source, the light comprising a target wavelength λ or the target range of wavelengths Δλ, wherein the metalens comprises a slab formed from a material having a first refractive index and a plurality of regions or features formed from a material having a second refractive index distributed on or over or across the slab. In some In some instances, the first refractive index can be higher than the second refractive index, and in some aspects, the plurality of regions define an optical modulation or manipulation or control structure for light having a target wavelength λ or the target range of wavelengths Δλ. Further, in some embodiments, a method comprises

Additional objects, advantages, and novel features of the technology will be set forth in part in the description which follows, and in part will become apparent to those skilled in the art upon examination of the following, or can be learned by practice of the invention modulating (or manipulating, modifying, changing, and/or controlling) light at the target wavelength λ or the target range of wavelengths Δλ

### BRIEF DESCRIPTION OF THE DRAWINGS

Aspects of the technology presented herein are described in detail below with reference to the accompanying drawing figures, wherein:

FIG. 1a shows a SEM image of an a-Si surface quality through E-Beam Sputtering deposition, in accordance with some aspects of the present technology;

FIG. 1b shows an SEM image of a-Si film deposited by E-Beam, in accordance with some aspects of the present technology;

FIG. 2a illustrates a S4 simulation model for aSi PCS structure on SiO₂ substrate, in accordance with some aspects of the present technology;

FIG. 2b illustrates a transmittance map with different lattice constant (y-axis) and different r/a (x-axis), in accordance with some aspects of the present technology;

FIG. 2c illustrates a transmission phase map with different lattice constants (y-axis) and different r/a (x-axis), in accordance with some aspects of the present technology;

FIG. 2d illustrates transmission (left y-axis) and phase change (right y-axis) for different r/a within fixed lattice (0.5 μm, the black dash line in (b) and (c)), in accordance with some aspects of the present technology;

FIG. 3a illustrates a curved surface lens design, in accordance with some aspects of the present technology;

FIG. 3b illustrates a metasurface flat lens phase map design, in accordance with some aspects of the present technology;

FIG. 4a is a schematic of an example photonic crystal slab metalens design, in accordance with some aspects of the present technology;

FIG. 4b illustrates transmission phase change along the black dashed line in (a), in accordance with some aspects of the present technology;

FIG. 4c is a schematic illustration of a transmissive focusing lens made of photonic crystal slab, in accordance with some aspects of the present technology;

FIG. 5 shows a module to estimate a beam spot, in accordance with some aspects of the present technology;

FIG. 6a shows the color map of the focal field distribution within x-z plane at y=0 for an example metalens, in accordance with some aspects of the present technology;

FIG. 6b shows the focal field distribution along z-axis at x=0, y=0 for an example metalens, in accordance with some aspects of the present technology;

FIG. 6c shows the color map of the focal field distribution within x-y plane at z=14 μm (focal length position) for an example metalens, in accordance with some aspects of the present technology;

FIG. 6d shows the focal field distribution along x-axis at y=0, z=14 μm for an example metalens, in accordance with some aspects of the present technology;

FIG. 7a shows a top view of SEM image of an example metalens (NA=0.05) device after RIE etching and EBL resist removal, in accordance with some aspects of the present technology;

FIG. 7b shows an SEM image to observe the radius changing of an example metalens, with lattice constant 500 nm, and radius of the largest and smallest air holes: 449.2 nm and 300.8 nm, in accordance with some aspects of the present technology;

FIG. 7c shows SEM images of side walls to observe etching quality by cleaving the buddy samples of an example metalens, in accordance with some aspects of the present technology;

FIG. 8a illustrates an example beam spot and working distance measurement setup, in accordance with some aspects of the present technology;

FIG. 8b illustrates an example metalens imaging measurement setup, in accordance with some aspects of the present technology;

FIG. 9a illustrates SEM image of the device of NA=0.1, which used to get testing results of (b)-(k), in accordance with some aspects of the present technology;

FIG. 9b illustrates the field distribution tracking of 850 nm incident light at x-z plane, in accordance with some aspects of the present technology;

FIG. 9c illustrates the x-y plane field distribution of 850 nm light at focal spot, in accordance with some aspects of the present technology;

FIG. 9d illustrates 850 nm light focal beam center field distribution along x- and y-axis, in accordance with some aspects of the present technology;

FIG. 9e illustrates 850 nm light focal beam center field distribution along x- and y-axis, in accordance with some aspects of the present technology;

FIG. 9f illustrates the field distribution tracking of 780 nm incident light at x-z plane, in accordance with some aspects of the present technology;

FIG. 9g illustrates the x-y plane field distribution of 780 nm light at focal spot, in accordance with some aspects of the present technology;

FIG. 9h illustrates 780 nm light focal beam center field distribution along x- and y-axis, in accordance with some aspects of the present technology;

FIG. 9i illustrates 780 nm light focal beam center field distribution along x- and y-axis, in accordance with some aspects of the present technology;

FIG. 10a illustrates imaging of an example metalens at 780 nm with NA varying from 0.25 to 0.15, in accordance with some aspects of the present technology;

FIG. 10b illustrates imaging of an example metalens at 780 nm with NA varying from 0.25 to 0.15, in accordance with some aspects of the present technology;

FIG. 10c illustrates imaging of an example metalens at 780 nm with NA varying from 0.25 to 0.15, in accordance with some aspects of the present technology;

FIG. 10d illustrates imaging of an example metalens at 850 nm with NA varying from 0.25 to 0.15, in accordance with some aspects of the present technology;

FIG. 10e illustrates imaging of an example metalens at 850 nm with NA varying from 0.25 to 0.15, in accordance with some aspects of the present technology;

FIG. 10f illustrates imaging of an example metalens at 850 nm with NA varying from 0.25 to 0.15, in accordance with some aspects of the present technology;

FIG. 11a is a schematic illustration of a 4-port system in a photonic crystal slab structure with lattice constant a, and airhole radius r, in accordance with some aspects of the present technology;

FIG. 11b illustrates transmittance and transmissive phase line over r/a ratio range (0.25 to 0.45) by varying both the air hole size and the lattice constant of a metalens, in accordance with some aspect of the present technology;

FIG. 11c is a schematic illustration of the transmissive focusing lens made of photonic crystal slab on glass, in accordance with some aspects of the present technology;

FIG. 12a is an electrical field intensity distribution contour plots on the x-z plane (propagation plane) of light passing through an example metalens, in accordance with some aspects of the present technology;

FIG. 12b is an electrical field intensity distribution contour plots on the x-z plane (focal plane) of light passing through an example metalens, in accordance with some aspects of the present technology; and

FIG. 12c is a diagram of simulated transmission efficiencies (circles) and the focal lengths (diamonds) over a broad spectrum band, in accordance with some aspects of the present technology.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different elements, steps, or combinations of steps and/or elements similar to the ones described in this document, in conjunction with other present or future technologies. Moreover, although the terms “step” and/or “block” can be used herein to connote different elements of methods employed, the terms should not be interpreted as implying any particular order among or between various steps disclosed herein unless and except when the order of individual steps is explicitly described.

Embodiments described herein can be understood more readily by reference to the following detailed description, examples, claims, and figures. Elements, systems, apparatus and methods described herein, however, are not limited to the specific embodiments presented in the detailed description, examples, claims, and figures. It should be recognized that these embodiments are merely illustrative of the principles of the present invention. Numerous modifications and adaptations will be readily apparent to those of skill in the art without departing from the scope of the invention. Accordingly, this disclosure is not intended to embrace all such alternatives, modifications and variations that fall within the scope of the technology.

All publications, patents and patent applications mentioned in this specification are incorporated herein in their entirety by reference, to the same extent as if each individual publication, patent, or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

It is also to be understood that the article “a” or “an” refers to “at least one,” unless the context of a particular use requires otherwise.

At a high level, aspects of the present technology relate to nanophotonics, metalenses, and/or flat optics, which in some instances can be based on photonic crystal slabs (PCS). Nanoscale metamaterials have drawn increasing attention for their use in, for example, lens systems or electronics for their broadband, highly efficient capabilities of modulation, for example phase modulation, by a flat medium. These flat optics or metasurfaces can be configured for a variety of applications in light beam manipulations, such as focusing, diverging, imaging formation of various beams (e.g. vortex beams) and projections (e.g. patterned spot projection). In some instances a metalens can be implemented as a focusing lens, transmission lens, diverging lens, reflecting lens, among others not inconsistent with the objectives of the present disclosure.

In one aspect, a photonic crystal slab (PCS) metalens structure can be configures to have full 2π phase modulation, high transmission efficiency, and broadband operation.

In some embodiments, a metalens (also referred to as a flat optic) is provided. In some embodiments, a metlens can comprise a slab or substrate, and one or more other optional layers. In some aspects, a metalens can comprise a plurality of regions, features, or structures distributed on, within, and/or across the slab. The distribution of the regions can be in any manner not inconsistent with the objectives of the technology, for example the distribution can be periodic, aperiodic, semi-random, random, among others. In some aspects the distribution of regions or features can be an array. In some aspects the distribution of regions can be a lattice. As will be appreciated, the regions or features can be arranged to permit interaction with light having a wavelength in a resonance manner. In some embodiments, the plurality of regions define an optical modulation structure for light, in some instances for light having a identified or target wavelength λ or a target range of wavelengths Δλ.

In some embodiments, the slab or substrate can be formed from a material having a first refractive index. In some instances, the slab can be formed from a dielectric material, semiconductor material, among others. The slab, in some instances, can be less than 500 nm thick, or less than 200 nm thick. In some instances, the slab can be disposed on a substrate, such as a glass substrate.

In some example embodiments, the slab can be formed from a-silicon or silicon. In some instances, the first refractive index can be from about 1 to about 10, or from about 1.5 to about 10. In some instances, the first refractive index is from about 3 to about 5. In some instances, the first refractive index is from about 1 to 6. In some instances, the first refractive index is up to about 10. In some instances, the first refractive index is up to about 7. In some aspects, the slab is a photonic crystal slab.

In some embodiments, the regions or features can be made or formed from a material having a second refractive index. In some embodiments, the second refractive index is lower than the first refractive index, or the first refractive index is higher than the second refractive index. In some instances, the regions or features can be formed as one or more holes (e.g. air holes), depressions, hollows, indents, and the like. The regions or features can take any shape not inconsistent with the objectives of the disclosure. For example, in some cases, the regions or features have a circular cross section at a surface. In some instances, the regions or features can be formed to have a square, triangular, geometric, semi-random, and/or random cross section at the surface. As will be appreciated, the regions or features can be formed from any method not inconsistent with the objectives of the present disclosure, for example through any type of etching.

In some instances the regions or features can be formed with another material (e.g. hole or hollow filled in) for example with a polymer, high refractive index polymer (HRIP), liquid crystal, amongst others. In some instances, the second refractive index is about 1. In some instances, the second refractive index is from about 1 to about 2. In some instances, the second refractive index is from about 1.3 to about 1.8. In some instances the second refractive index.

In some aspects, the difference between the first refractive index and the second refractive index (i.e. A refractive index) is at least 0.1. In some instances the difference between the first refractive index and the second refractive index is about 0.5. In some instances, a low or lower index contrast can be defined and/or configured. In some other instances, a high or higher index contrast can be defined and/or configured.

According to some embodiments, the plurality (e.g. one or more) regions or features can define an optical modulation and/or manipulation, and/or modification structure for light having the target wavelength λ or the target range of wavelengths Δλ. It can be understood that an optical modulation or modification structure as described herein can modulate, modify, manipulate, change, or control one or more parameters of light. For example, in some instances, amplitude, phase, and or polarization can be modified or changed or controlled. In some instances, such a structure can be configured to modulate or modify light spatially from 0 to 2π. In some instances, the regions or features can define an optical resonance structure for light having the target wavelength λ or the target range of wavelengths Δλ. In some instances, the regions or features can define an optical refractive index modulation structure.

In some embodiments, based on the configuration of the plurality of regions, the metalens can exhibit up to 2π transmissive phase modulation. In some other embodiments, based on the configuration of the plurality of regions, the metalens can exhibit up to 2π reflective phase modulation. In some aspects, the metalens can be configured or designed for a target phase change profile.

In some aspects, the slab and/or the plurality of regions are transparent at the target wavelength A or the target range of wavelengths Δλ. For instance, the slab and/or the plurality of regions can be at least 50% transparent, 60% transparent, 70% transparent, 80% transparent, 90% transparent, at least 90% transparent, at least 95% transparent at the target wavelength λ or the target range of wavelengths Δλ. In some instances, as will be appreciated, the transparency of the slab and/or the plurality or regions can refer to a non-absorbance. In some aspects, the slab and/or the plurality of regions have a non-absorbance at the target wavelength λ or the target range of wavelength. For example, the slab and/or the plurality of regions can have a non-absorbance of at least 80%, at least 90%, at least 95% at the target wavelength λ or the target range of wavelengths Δλ. In some further aspects, the metalens (or one of the slab and/or the regions or features) has less than 20% loss, or less than 10% loss (e.g. through absorption) in reflection or transmission.

In some aspects, the target wavelength λ or the target range of wavelengths Δλ for the metalens, or more particularly for the optical modulation and/or modification structure, optical resonance structure and/or optical refractive index modulation structure can be from ultraviolet (UV), to infrared (IR) and tetrahertz (THz). In some example embodiments, the target wavelength λ or the target range of wavelengths 42 can be between 300 nm to 3 μm. In some aspects, the target wavelength λ or the target range of wavelengths Δλ can be between 1 μm to about 25 μm.

According to some other embodiments, metalenses are described herein. In another aspect, methods of making a metalens or plurality of metalenses is described herein. In some embodiments, such a metalens can comprises a flat sub-wavelength nanostructure. In some preferred embodiments, a metalens described herein comprises a photonic crystal slab (PCS) comprising an array or lattice of air holes, wherein the air holes have a radius r, and wherein the lattice has a lattice constant a. Moreover, as understood by a person of ordinary skill in the field, a photonic crystal slab can comprise an optical nanostructure having a periodic variation of refractive index.

Moreover, it is to be understood that the air holes of a metalens described herein can have any shape and/or size not inconsistent with the technical objectives of the present disclosure. For example, in some cases, the air holes have a circular cross section at a surface of the slab (e.g., the top surface and/or bottom surface of the slab). However, other shapes (e.g., square, triangle, and any other shape not inconsistent with the objectives of this disclosure) are also contemplated herein. Circular air holes described herein have a radius r. It is to be understood that air holes having non-circular shapes can have a dimension or feature that is analogous to the radius of a circular air hole (e.g., an air hole having a square shaped cross section may have a certain width rather than a radius). In such instances, the following description of the radius of a population of air holes can be replaced with the analogous dimension or feature. For example, if the air hole is square in shape, the measurement may be described by the length of the side of the square.

Further, it is to be understood that the lattice constant a of the air holes described herein is the distance between two adjacent air holes measured from the center to the center of the adjacent air holes (in the plane of the surface of the PCS). For example, if the air holes are circular, the lattice constant a would be measured from the center of one circular air hole to the adjacent circular air hole. If the air holes are square in shape, the lattice constant a would be measured from the center of one square air hole to the adjacent square air hole. If the air holes are irregular in pattern, in the sense that the air holes do not all have the same cross sectional shape, size, and spacing, as described below, the lattice constant a would be measured from the center of one air hole and the next adjacent air hole matching the same corresponding shape, size, and spacing.

As described herein, in some embodiments, an array or lattice of air holes is a regular array or lattice. An array or lattice of air holes can also be irregular. For reference purposes herein, a “regular” array or lattice includes air holes all having the same cross sectional shape, size, and spacing. An “irregular” array or lattice, by contrast, includes a population of air holes that do not all have the same cross sectional shape, size, and spacing. For instance, in some embodiments of an irregular array or lattice, the radius of the air holes differs in one region of the PCS compared to a different region. Similarly, the shape and/or spacing of the air holes may also vary from one region of the PCS to another region of the PCS.

Further, in some instances, a metalens described herein exhibits or provides continuous 2π transmissive phase modulation or control. In some instances, a metalens described herein exhibits or provides continuous 2π reflective phase modulation or control. As described further herein, in some cases, such control can be provided by selecting a combination of the radius (or analogous parameter) and lattice constant of the metalens. Thus, in some cases, the radius (or analogous parameter) and lattice constant are configured to achieve continuous 2π transmissive phase control of incident light.

In some embodiments, the radius of the airholes is between 50 nm and 200 nm. In other cases, the radius of the airholes is between 50 nm and 150 nm. In some instances, the radius of the airholes is between 50 nm and 100 nm, between 100 nm and 150 nm, between 100 nm and 200 nm, or between 150 nm and 200 nm.

Moreover, in some instances, the lattice constant is between 50 nm and 500 nm. In some embodiments, the lattice constant is between 50 nm and 400 nm, 50 nm and 300 nm, 50 nm and 200 nm, 50 nm and 100 nm, 100 nm and 500 nm, 100 nm and 400 nm, 100 nm and 300 nm, 100 nm and 200 nm, 200 nm and 500 nm, 200 nm and 400 nm, 200 nm and 300 nm, 300 nm and 500 nm, 300 nm and 400 nm, and 400 nm and 500 nm.

Further, in some embodiments, a ratio of the radius r to the lattice constant a (r/a) is greater than 0.4. In other embodiments, r/a is less than 0.4. In some instances, the ratio r/a ranges from 0.2 to 0.6, 0.2 to 0.5, 0.2 to 0.4, 0.3 to 0.6, or 0.3 to 0.5.

In some instances, the phototonic crystal slab comprises or is formed from amorphous silicon. In some other embodiments, the metalens further comprises a glass substrate or quartz. Additionally, in some such cases, the phototonic crystal slab is disposed on the glass or quartz substrate.

Moreover, in some other instances, the photonic crystal slab has an average thickness of less than 1 μm. In other embodiments, the photonic crystal slab has an average thickness of less than 750 nm. In other embodiments, the photonic crystal slab has an average thickness of less than 500 nm. In some other instances, the photonic crystal slab has an average thickness of less than 400 nm or less than 300 nm. In other cases, the photonic crystal slab has an average thickness of less than 200 nm.

Further, in some embodiments, the slab or photonic crystal slab of a metalens described herein is a rectangular prism. In other embodiments, the photonic crystal slab is a square prism. In some other embodiments, the photonic crystal slab is less than 50 μm in length. In other instances, the photonic crystal slab is less than 40 μm in length. In other embodiments, the photonic crystal slab is less than 30 μm in length. In some other instances, the photonic crystal slab is less than 20 μm in length. In some other embodiments, the photonic crystal slab is less than 50 μm in width. In other instances, the photonic crystal slab is less than 40 μm in width. In other embodiments, the photonic crystal slab is less than 30 μm in width. In some other instances, the photonic crystal slab is less than 20 μm in width.

Further, in another aspect, a method for making or fabricating a metalens or a plurality of metalenses is provided. In some embodiments, such a method comprises forming a photonic crystal slab (PCS) comprising an array or lattice of air holes, wherein the air holes have a radius r, and the lattice has a lattice constant a; and selecting the radius r and the lattice constant a to provide continuous 2π transmissive phase modulation by the metalens or plurality of metalenses. The metalens or plurality of metalenses can have any of the properties described herein for a metalens.

### Examples

Various aspects of the present technology are further illustrated through the following non-limiting examples.

1. Metalens design and applications. As described herein, flat optics or metasurfaces have applications in beam manipulations, such as focusing/imaging, formation of vortex beam, and patterned spot projection. A common metamaterial is dielectric pillar structures placed on the applicable substrate with tailored shapes, separation rotation, and placement to bend the transmitted light in the desired way. The mechanism of the localized scattering in these structures often requires the material thickness to be at micrometer scale to provide long enough light paths and to achieve a continuous complete 2π phase transition range. It thus hinders the full adoption of the technology in commercialized products, which have higher durability requirements. An amorphous silicon photonic crystal slab (PCS) metalens structure with full 2π phase modulation, high transmission efficiency, and broadband operation centered at 940 nm is described herein. The design of a focusing PCS metalens is also verified with COMSOL and a 3-dimensional large area finite-difference time-domain (FDTD) method. In some aspects, structures described herein can be configured for large area phase manipulation with compact, reliable, and low aspect ratio patterning on thin film. In some aspects efficiency can be greater than 80% with operating wavelengths over 100 nm.

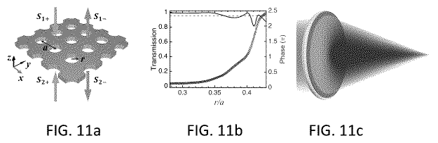

Shown in Error! Reference source not found. 11aError! Reference source not found. is a schematics of a photonic crystal slab (PCS) with lattice constant a, airhole radius r, and its 4-port transportation matrix S. In some embodiments described herein, for a PCS on a glass substrate, these parameters can be tuned to achieve continuous 2π transmissive (or reflective, in some cases) phase control. In other embodiments described herein, by construction of in-plane phase distribution according to the phase-radius line in FIG. 11b, a highly efficient focusing metalens is achieved as illustrated in in FIG. 11c.

Coupled mode and formation of 2π phase continuity. The PCS guided resonance modes were quantitatively analyzed by the coupled mode theory, which establishes the temporal relation of transmittance, reflectance, and the resonant modes that exhibits Fano line shape in the spectrum. Not intending to be bound by theory, the PCS modes also proposed the condition for reflective 2π phase formation. Similar procedures can be used to derive conditions for transmissive 2p phase formation. Not intending to be bound by theory, the condition for having a transmissive 2π phase continuity is that the PC transmission coupling strength should be larger than the background transmission. This condition is satisfied for modes that degenerate near the edge of a broad high transmission band. The amorphous silicon PCS-on-glass structure was investigated, and it was found that the degenerate mode occurs at slab thickness t=160 nm, a=500 nm and rla>0.4 for working wavelength at 940 nm. It was then possible to construct a various phase plate by varying the air hole radius (thus, the rla ratio) only to achieve the 2π phase line. In some embodiments, it was also discovered that further improvements on transmission efficiency can be realized by changing both the air hole radius and the lattice constant. In other embodiments, close to 100% transmission can be achieved for the designs, as shown in FIG. 11c.

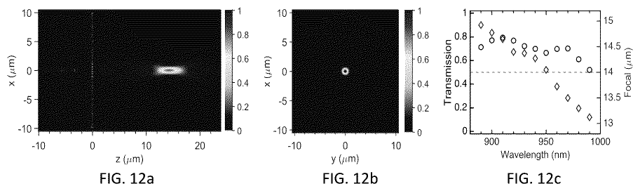

Photonic crystal focusing metalens. To verify the phase modulation capability of the PC-on-glass structure, a focusing metalens with side length of 21 μm×21 μm was constructed in the FDTD tool Tidy3D. The in-plane phase distribution is in a hyperboloidal profile, increasing from 0 at the center outwards. Since the PCS structure is polarization independent, for an incident planewave with p-polarization (E-field in x-direction), the focusing effect is visualized in FIGS. 12a and 12b, for the total electric field intensity on the x-z plane (propagating plane) and the x-y plane (focal plane), respectively. For this design, the PCS metalens had a focal length of 14 μm and a spot size of 0.79 μm. This agrees well with the lens focal equation theory. Additionally, the lens can operate in a broadband region, with transmission efficiency of 60% to 80%, over a 100 nm spectral band, as shown in FIG. 12c. As will be appreciated, FIG. 12 illustrates results for light passing through the focusing lens at 940 nm, where z=14 μm and in FIG. 12c, the dashed line shows an the analytical focal length of 14 μm at 940 nm.

As shown in the above example, in some embodiments, transmission 2π phase control can be achieved by the air hole PCS structures. In some instances, the PCS metalens has transmission efficiency of 60% to 80% over 100 nm spectral bandwidth. In some embodiments, the PCS metalens has comparable performances with the traditional meta-atom metalens. The PCS-metalens design is structurally thinner and mechanically more robust because of the thin film configuration. This metalens is further verified by FDTD and COMSOL simulations.

2. Design and validation of silicon optical modulators. In some aspects, a simulation and design platform for silicon optical modulators is provided, including optical resonance design with PCS structure, electro-optical modulation based on the free carrier plasma effect in silicon, optical and electrical modulation overlap design, and frequency response and bandwidth estimation. Bandwidth of GHz response can be achieved with the designed structure. The design method can be applied to different semiconductor platforms that has free carrier response in the capacitor like structure. To validate the phase control based on the example a-Si on quartz substrate, a PCS based metalens structure was determined and configured, where 2π phase change was designed and demonstrated experimentally. The PCS metalens focusing properties match well with the target designs, and the metalens generated good imaging. The results illustrate the design can achieve full 2p phase control in these materials at both 1550 nm and 940 nm wavelength ranges.

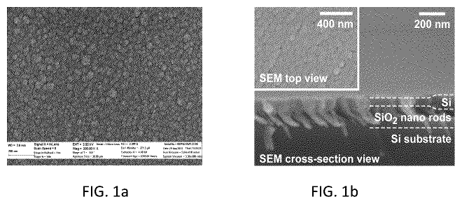

a-Si on quartz substrate development. Fabrication of the substrate starts with deposition of a 158 nm layer of a-Si on standard quartz wafer of 500 μm thickness. The camber pressure is kept at 3.3 mTorr, Ar gas follow set 30 sccm and the power is 200 W. FIG. 1a shows the deposited a-Si layer surface quality, and there are cracks due to the low deposit quality. FIG. 1b shows another a-Si electron-beam deposition results. Both of them have a crack issue, and the material index will reduce due to air mixed into the crack region. Here, an a-Si index can be determined to be is n=2.94@632.8 nm.

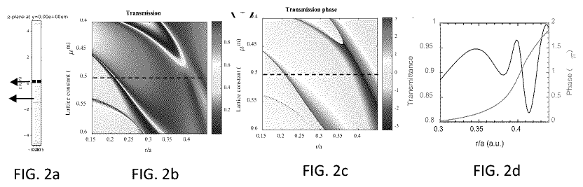

Design of a-Si PCS at 940 nm and PCS metalens. In the metalens designs, it is important to calculate and design the transmission phase through the a-Si/SiO₂ structure. FIG. 2a shows a simulation model to calculate the transmittance and phase using S4 software. The light is incident from air to the a-Si PCS layer (square lattice, circular air hole), passing through the SiO₂ substrate. FIGS. 2b and 2c show the transmission and phase varying with lattice and air filling ratio r/a. The target is to find the highest transmission with at a working wavelength of 940 nm. The configured PCS thickness is h=160 nm, and lattice of PC is fixed at a=500 nm and the air hole diameters between 300 nm to 448 nm (0.3<r/a<0.448) to achieve the 2π phase shift in the transmission. Higher than 82% transmission can be obtained, as shown in FIG. 2d.

Lens phase map design and performance estimation.

For a focusing lens with a numerical aperture (NA) definition:

$$N A = n \cdot sin ( θ ) \qquad ( 1 )$$

where n is refractive index of material outside the lens. Assuming lens in the air,

$$N A = sin ( θ ) \qquad ( 2 )$$

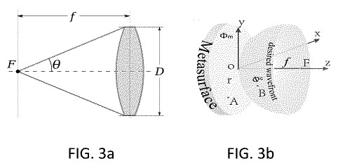

Based on the trigonometric functions and relation in FIG. 3Error! Reference source not found.a structure:

$$cos ( θ ) = \sqrt{1 - sin {( θ )}^{2}} = \sqrt{1 - N {A}^{2}} \qquad ( 3 )$$

$$tan ( θ ) = \frac{D}{2 f} \qquad ( 4 )$$

where D is the lens diameter, and f is the focal length. Combine Eq. (3) to (6):

$$\frac{N A}{\sqrt{1 - N {A}^{2}}} = \frac{sin ( θ )}{cos ( θ )} = tan ( θ ) = \frac{D}{2 f} \qquad ( 5 )$$

Finally, the relation between NA and f can be described as:

$$f = \frac{D}{2 N A} \sqrt{1 - N {A}^{2}} \qquad ( 6 )$$

For the cylindrical coordinate, the whole lens phase map could be described as:

$$φ ( r , ω ) = - \frac{ω}{c} ( \sqrt{{r}^{2} + {f}^{2}} - f ) \qquad ( 7 )$$

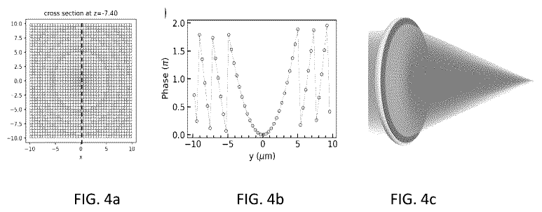

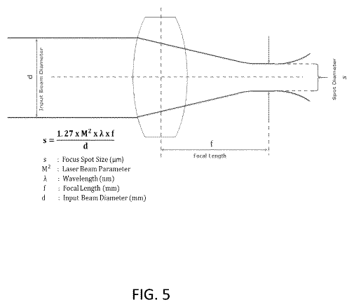

Combine phase map of different r/a at a=500 nm (FIG. 2d) with metalens phase map (Eq. (10)) of D=20 μm, NA=0.6 (estimated f=14 μm), the designed metalens phase map is shown in FIG. 4b and the sketch of the light focusing process shown as FIG. 4c. Error! Reference source not found. FIG. 5 shows the estimated beam spot theory:

$$S = \frac{1.27 \times {M}^{2} \times λ \times f}{d} \qquad ( 8 )$$

where M² describe the incident beam spot shape quality (M²>1), λ is working wavelength, f is lens focal distance and dis lens diameter.

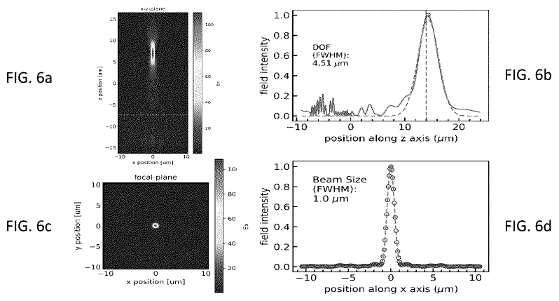

a-Si PCS metalens design. To verify the phase modulation capability of the PC-on-glass structure, a focusing metalens was constructed with side length of 20 μm×20 μm in the FDTD tool Tidy3D. The in-plane phase distribution is in a hyperboloidal profile, increasing from 0 at the center outwards. Since the PCS structure is polarization independent, for an incident planewave with p-polarization (E-field in x-direction), the focusing effect is visualized in FIGS. 6a and c, for the total electric field intensity on the x-z plane (propagating plane) and the x-y plane (focal plane), respectively. For this design, the PCS metalens has a focal length of 14 μm, and a spot size of 0.84 μm as shown in FIGS. 6b and 6d. This agrees well with the lens focal equation theory. Table 1 shows the simulation parameters of metalens and estimated performance.

Table 1 shows design parameters for an example PCS metalens.

TABLE 1

| Parameters | Value | |
|---|---|---|
| Side length (D) | 20 | μm |
| thickness | 160 | nm |
| Lattice (a) | 500 | nm |
| r/a | 0.3~0.448 (300 nm < D < 448 nm) | |
| lens diameter | 20 | um |
| NA | 0.6 | |
| Focal length (f) | 14 | μm |

| | |
|---|---|
| Beam Size | 0.84 μm (1 μm for simulation) |

Device fabrication and performance.

EBL and RIE etching.

EBL and RIE etching processes were used for the PCS structure fabrication. The PCS pattern is fabricated on a 158 nm thickness a-Si device layer on a 500 μm thickness quartz substrate. The quartz substrate is insulating material which introduces charging and distortion to the imaging system issue during standard EBL process. Here, a conductive polymer (Discharge H2O) was deposited to the sample surface and updated EBL process flow to minimize the charging issue for the EBL tool with working voltage of 50 kV. The PCS metalens written area size is 500 μm×500 μm, and we designed 5 metalens with different NA (0.25, 0.2, 0.15, 0.1 and 0.05). After patterning, the DRIE-Etcher-TRION tool is used for etching the metalens devices. During etching process, the chamber pressure keeps at 10 mTorr, RIE RF power set 50 W, He pressure set 4 mTorr, O₂ gas flow set 10 sccm, SF₆ set 5 sccm and CHF3 set 35 sccm and the total etching time is 250 seconds.

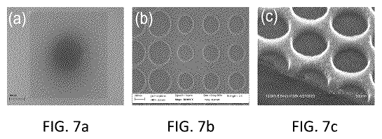

FIG. 7a shows the whole structure profile of NA=0.05 metalens device, and FIG. 7b show its zoomed-in top views. Obviously, the structure shape change is smooth and matched the phase map design. FIG. 7c show the etching results for the side wall cleaved by buddy samples. The smallest circle diameter is 300.8 nm and the designed smallest diameter at same position is 302 nm (the offset is 1.2 nm); the designed biggest circle diameter is 448 nm, and the measured biggest diameter is 449.2 nm at same location, (offset is 1.2 nm). The measured lattice constant is 500 nm which is same as designed.

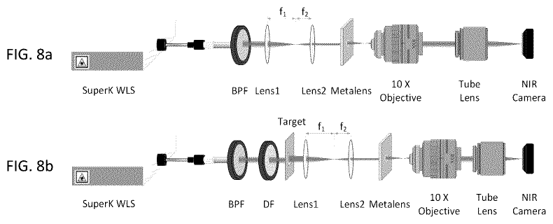

Four characteristics of the a-Si PCS/quartz metalens: 1. Focal distance, 2. Focal beam spot, 3. Metalens imaging ability and 4. Focal efficiency. The FIG. 8a shows the focal ability measurement setup, which contains a SuperK white light laser source (with bandpass filter 780 nm and 850 nm separately) and two lens 4f system (using for reduce beam size to match metalens size), metalens device, objective lens, tube lens and beam profiling camera (Beammic SP932U). The objective lens combines with tube lens to amplify the focal beam spot. In the measurement setup, the objective lens is 10π magnitude, so the image captured by camera should be 10 times larger than the real size. And the XYZ stage controls the location of the metalens device to align the incident beam directly through the metalens. She stage is also used to move the image system along the optical axis of the metalens and track the beam focusing performances. FIG. 8b shows the imaging ability measurement setup, which contains a SuperK white light laser source (with bandpass filter 780 nm and 850 nm separately), diffusor to reduce laser coherent to avoid sparkle effect, 1985 USAF target, two lens 4f system (using for reducing beam size to match metalens size), metalens device, objective lens, tube lens and beam profiling camera (Beammic SP932U).

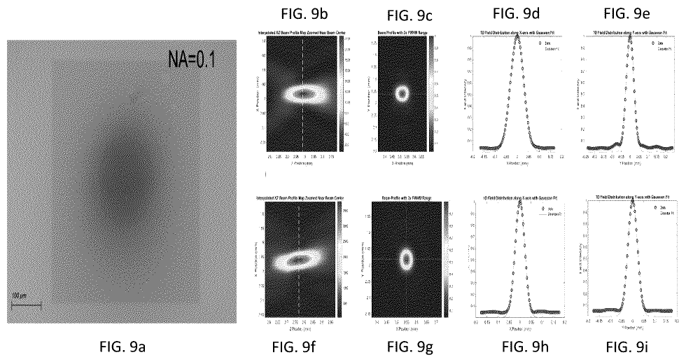

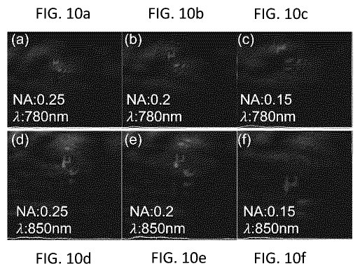

Based on the Eq. (6), the theoretically calculated focal distance of the this metalens (D=500 μm, NA=0.1) is 2.46 mm, and the FIG. 9 (b) and (f) show the measured focal distances are 2.77 mm (at 850 nm) and 2.99 mm (at 780 nm) separately. Obviously, the focal distance slightly larger than the theoretically estimated value, and the longer wavelength beam has short focal distance, which tendency is confirmed by other metalens also (as shown in Table 1). FIG. 9 (c) shows the 850 nm incident light intensity plot taken at 2.77 mm and focusing beam spot is observed with diameter is D(x)=79.4 μm and D(y)=55.2 μm in the camera image. The real diameter of the beam spot should be D(x)=7.94 μm and D(y)=5.52 μm by considering the camera image is amplified by 10π objective lens. FIG. 9 (g) shows the 780 nm incident light intensity plot taken at 2.99 mm and focusing beam spot is observed with diameter is D(x)=58.7 μm and D(y)=58.6 μm in the camera image. The real diameter of the beam spot should be D(x)=5.87 μm and D(y)=5.86 μm. Based on the Eq. (9), the estimated beam spot diameter should be 5.37 μm and 4.93 μm at 850 nm and 780 nm. The offset between the average measured and estimated spot diameter are 1.36 μm (at 850 nm) and 0.93 μm (at 780 nm). FIG. 9 (d)-(e) and (h)-(i) show the beam center intensity distribution along x and y axis at 850 nm and 780 nm separately. All 1-D intensity distribution matched with Gaussian fitting (the red curve) which means the metalens is working to get a good single mode focusing at 850 nm and 780 nm. FIG. 10 (a)-(c) show image of the 1985 USAF target at 780 nm generated by metalens with NA=0.25 to 0.15. And FIG. 10 (d)-(f) show image of the 1985 USAF target at 780 nm generated by metalens with NA=0.25 to 0.15. All that images are received by Beammic SP932U. The image resolution increasing via NA value increasing, and 780 nm and 850 nm incident light shows same tendency. The reason is the focal efficiency reduced by the NA reducing let the metalens imaging ability reducing. At same time, the image scale is reducing with the NA increasing. The reason is that the lens (f1) before metalens and metalens (f2) cooperated as 4f system, the image magnitude is related to the radio f2/f1; based on Eq. (6), the focal distance (f2) will be increased by reducing NA (the results are confirmed by the measurement and shown in) and the f2/f1 ratio will increase, so the image magnitude will increasing by NA reducing. Table 2 shows all device measurement performance, all of them working good for 850 nm and 780 nm light, so that confirm the metalens own wild working bandwidth (780 nm to 850 nm at least).

Table 2 shows example metalens devices measurement performance.

TABLE 2

| | | | Focal | Beam | Focal |
|---|---|---|---|---|---|
| NA | | Wavelength(nm) | Length(mm) | diameter(μm) | efficiency(%) |
| 0.05 | Theory | 780 | 4.994 | 9.89 | — |
| | | 850 | 4.994 | 10.78 | — |
| | | 940 | | | — |
| | Measurement | 780 | 6.0 | 12.07 | |
| | (average) | 850 | 5.5 | 11.04 | |
| | | 940 | | | |
| 0.1 | Theory | 780 | 2.49 | 4.93 | — |
| | | 850 | 2.49 | 5.37 | — |
| | | 940 | | | — |
| | Measurement | 780 | 2.99 | 5.86 | |
| | (average) | 850 | 2.77 | 6.73 | |
| | | 940 | | | |
| 0.15 | Theory | 780 | 1.65 | 3.26 | — |
| | | 850 | 1.65 | 3.58 | — |
| | | 940 | | | — |
| | Measurement | 780 | 1.98 | 4.14 | |
| | (average) | 850 | 1.88 | 5.17 | |
| | | 940 | | | |
| 0.2 | Theory | 780 | 1.22 | 2.43 | — |
| | | 850 | 1.22 | 2.64 | — |
| | | 940 | | | — |
| | Measurement | 780 | 1.47 | 3.28 | |
| | (average) | 850 | 1.36 | 4.31 | |
| | | 940 | | | |
| 0.25 | Theory | 780 | 0.97 | 1.92 | — |
| | | 850 | 0.97 | 2.09 | — |
| | | 940 | | | — |
| | Measurement | 780 | 1.18 | 2.93 | |
| | (average) | 850 | 1.07 | 3.97 | |
| | | 940 | | | |

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

1. A metalens comprising:
a slab; and
a plurality of regions distributed on the slab,
wherein the slab is formed from a material having a first refractive index,
wherein the plurality of regions is formed from a material having a second refractive index,
wherein the first refractive index is higher than the second refractive index, and
wherein the plurality of regions define an optical modulation structure for light having a target wavelength λ or a target range of wavelengths Δλ.

2. The metalens of claim 1, wherein the slab is transparent at the target wavelength λ or over the target range of wavelengths Δλ.

3. The metalens of claim 1, wherein the plurality of regions are transparent at the target wavelength λ or over the target range of wavelengths Δλ.

4. The metalens of claim 1, wherein the metalens exhibits up to 2π transmissive phase modulation.

5. The metalens of claim 1, wherein the metalens exhibits up to 2π reflective phase modulation.

6. The metalens of claim 1, wherein the target wavelength λ or a target range of wavelengths Δλ is from ultraviolet (UV) to infrared (IR) and/or tetrahertz (Thz).

7. The metalens of claim 1, wherein the target wavelength λ or a target range of wavelengths Δλ is between 300 nm 3 μm.

8. The metalens of claim 1, wherein the first refractive index is from 1 to 10.

9. The metalens of claim 1, wherein the second refractive index is about 1.

10. The metalens of claim 1, wherein the second refractive index is from 1 to 2.

11. The metalens of claim 1, wherein the slab has an average thickness of less than 500 nm.

12. The metalens of claim 1, wherein the slab is disposed on a substrate.

13. The metalens of claim 1, wherein the difference between the first refractive index and the second refractive index is at least 0.1.

14. The metalens of claim 1, wherein the optical modulation structure comprises a optical refractive index modulation structure.

15. The metalens of claim 1, wherein the plurality of regions comprises holes.

16. A method of modulating light, the method comprising:
receiving, at a metalens, light from a light source, the light comprising a target wavelength λ or the target range of wavelengths Δλ, wherein the metalens comprises:
a slab formed from a material having a first refractive index; and
a plurality of regions formed from a material having a second refractive index distributed on the slab,
wherein the first refractive index is higher than the second refractive index, and
wherein the plurality of regions define an optical modulation structure for light having the target wavelength λ or the target range of wavelengths Δλ; and
modulating light at the target wavelength λ or the target range of wavelengths Δλ.

17. The method of claim 13, wherein the light is modulated in the 2π transmissive phase.

18. The method of claim 13, wherein the light is modulated in the 2π reflective phase.

19. The method of claim 13, wherein the first refractive index is from 1 to 10.

20. The method of claim 13, wherein the second refractive index is from 1 to 2.
